(19) United States
(12) Patent Application Publication
(10) Pub. No.: US 2022/0314538 A1
(43) Pub. Date: Oct. 6, 2022

(54) RESERVOIR-3D-PRINTHEAD

(71) Applicant: BIGREP GMBH, Berlin (DE)

(72) Inventors: Sandro BAYER, Berlin (DE); Moshe AKNIN, Berlin (DE)

(73) Assignee: BIGREP GMBH, Berlin (DE)

(21) Appl. No.: 17/628,088

(22) PCT Filed: May 26, 2020
(86) PCT No.: PCT/EP2020/064480

§ 371 Date: Jan. 18, 2022

(30) Foreign Application Priority Data
Jul. 18, 2019 (LU) LU101314

(51) Int. Cl. B29C 64/209; B33Y 30/00; B29C 64/321; B33Y 40/00

(52) U.S. Cl. CPC B29C 64/209; B33Y 30/00; B29C 64/321; B33Y 40/00

(57) ABSTRACT

The Invention relates to a 3D-printhead and a 3D-printer comprising a positive displacement pump, a reservoir and a liquefier, wherein said liquefier is upstream of said reservoir, and wherein said reservoir is upstream of said positive displacement pump.

### FIELD

The present invention relates to 3D-printing or additive manufacturing. In particular, the present invention relates to a reservoir printhead for a 3D-printer or additive manufacturing machine.

### BACKGROUND

In the field of additive manufacturing an additive manufacturing machine is also called a 3D-printer. In 3D-printing objects or workpieces are built/created/generated by subsequent depositing layers (beads or strands) of build material onto each other. This build material may be plastic material and in particular, the depositing process may be the known FFF process. The build material supplied to the 3D-printer may be filament or granulated material.

The 3D-printer usually comprises a 3D-printhead that moves in three dimensions by means of a motion system the 3D-printhead is attached to. This motion system may be a gantry system. Also, there are 3D-printers that comprise a printhead that moves in two dimensions and a printbed (the surface or structure on/to which the workpiece(s) are created) that moves in the third dimension. Also, there are printheads that are mounted to a conventional industrial robot such that the printhead can realize complex printing trajectories (paths the 3D-printhead follows while depositing build material in order to create the workpiece). The printhead generally comprises an apparatus to apply the build material to create the workpiece.

In the field of FFF printing, the printhead conventionally may comprise a liquefier and a material feed unit. Sometimes the printhead further comprises a melt pump or positive displacement pump downstream the liquefier. Such melt pump may be a gear pump. The material feed unit supplies build material (the material from which the workpiece is created) to the liquefier and subsequently (if applicable) to the melt pump. In the printhead said build material is heated up to its melting temperature. In particular, the build material is heated up in the liquefier and deposited through a nozzle that is connected to the liquefier or melt pump. The deposited build material forms a deposited strand that in turn forms one layer or part of a layer of the workpiece being built. An outlet opening of the nozzle (material outlet) has usually a circular cross section, however, other shapes are possible. The heated and plastic-state build material leaves the printhead/the nozzle trough said outlet opening to form the workpiece(s). The print head may use any known technology such as positive displacement pumps, material feed units (e.g. friction wheel units), screw extruders, gear pumps, liquefiers, tube liquefiers, or any combination of these.

With present 3D-printheads, in particular in the field of FFF, the rate at which the build material can be deposited (weight unit per time unit or volume unit per time unit) is connected to the melting rate of the liquefier. In other words, if the needed deposition rate exceeds the melting rate of the liquefier, the positive displacement pump starves and e.g. the quality of the workpiece and/or the print speed reduces.

Further, said deposition rate is dependent on the actual geometry of the workpiece being printed in that moment. This means that said deposition rate changes all the time and also may rapidly change. If the 3D-printhead for example prints a straight part or along a straight part of a printing trajectory, the 3D-printhead can move fast along the trajectory thus demanding a high deposition rate. However, if the straight part of the printing trajectory is for example followed by a sharp corner, the 3D-printhead has to slow down considerably and thus the deposition rate has to reduce also considerably. The faster the overall printing speed should be, the faster such drastic changes in the deposition rate are needed. With current 3D-printheads this poses problems since the liquefier and ultimately the feed unit cannot follow the quick changes regarding the deposition rate as needed. This limits the overall printing process regarding printing speed and achievable quality of the workpiece.

Object of the present application is to overcome the aforementioned limitations and to provide a 3D-printhead that can react to quick, drastic and frequent changes of the needed deposition rate in order to increase the overall printing speed and/or quality. Thus, this object is solved by apparatuses according to the appended independent claims.

According to an aspect of the present disclosure a 3D-printhead comprises a positive displacement pump, a reservoir and a liquefier. Said liquefier is located upstream of said reservoir. Said reservoir is located upstream of said positive displacement pump. This may have the advantage that the build material molten by the liquefier is buffered in said reservoir and thus uncoupling to some extend the deposition rate of the 3D-printhead/the positive deposition pump from the melting rate of the liquefier. In other words, the deposition rate can vary very quickly without the need that the melting rate of the liquefier has to follow. This may have the further advantage that the liquefier may be operated in a certain range of the melt rate within which the liquefier works best.

According to another aspect of the present disclosure a 3D-printhead further comprises at least one of a nozzle and/or a heat sink and/or a Bowden tube. Said Bowden tube is located upstream of said heat sink and said liquefier. Said heat sink is located upstream of said liquefier. Said positive displacement pump is located upstream of said nozzle.

Said heat sink may have the advantage that the material entering the liquefier is not affected by the heat generated by the liquefier and thus its structural integrity or stability is not diminished by any heat influence of the liquefier. This may have the advantage that the material feed unit forces the build material down the Bowden tube into the liquefier. If the build material in the Bowden tube is influenced by the heat of the liquefier then there is the risk that the material feed unit cannot force enough build material in the liquefier. There may be the further advantage that molten build material cannot enter the Bowden tube and clog the Bowden tube in case, as it solidifies in the area of the heat sink and being again forced into the liquefier by the build material coming from the Bowden tube or material feed unit.

Said Bowden tube may have the advantage that it guides the build material being fed by the material feed unit to the liquefier. Since the build materials is still in a solid state while being within the Bowden tube, the material feed unit can apply force on the build material to force it into the liquefier. Since the build material is guided by the Bowden tube it cannot spread and the material feed unit can apply a greater force on the material. In case the material feed unit is located in some distance to the 3D-printhead, the Bowden tube may also be a Bowden cable. This might be the case if the material feed unit is located on a static portion of a 3D-printer in order to reduce the mass of the 3D-printhead to be moved by the motion system (e.g. gantry system) the 3D-printhead is attached to. This may have the advantage that the motion system can move the 3D-printhead with high accelerations due to the reduced mass. In such a case the connection between the material feed unit and the liquefier needs to be flexible yet rigid enough to guide the build material fed by the material feed mechanism to the 3D-printhead. The reservoir in the 3D-printhead can compensate fluctuations in the supply of build material from the material feed unit to the liquefier that might occur due to the increased distance between the material feed unit and the liquefier.

The build material conveyed by the positive displacement pump is deposited by the nozzle to the workpiece or build platform. The nozzle is located down stream of the positive displacement pump. The nozzle may be a unitary part with a part or element of the positive displacement pump or may be a separate part e.g. to be screwed in the positive displacement pump.

According to another aspect of the present disclosure a 3D-printhead further comprises a material feed unit. The material feed unit is located upstream and operatively coupled to one of said Bowden tube or said heat sink or said liquefier. In this case the material feed unit is moved by the motion system. This may have the advantage that the distance between the material feed unit and the liquefier is short and thus the material feed unit can apply a greater force onto the build material being forced by the material feed unit down the Bowden tube into the liquefier. This may increase the melt rate of the liquefier.

According to another aspect of the present disclosure the positive displacement pump of the 3D-printhead is a gear pump. This may have the advantage that a precise deposition rate can be achieved by a relatively simple and cost effectively design.

According to another aspect of the present disclosure a 3D-printhead further comprises at least one heating element that heats the reservoir. This may have the advantage that the molten material in the reservoir may be kept at an ideal temperature for the subsequent depositing process.

According to another aspect of the present disclosure the reservoir of a 3D-printhead has at least two temperature zones. This may have the advantage to adjust the amount and timing of heat energy getting into the molten build material within the reservoir. The different temperature zones may be achieved by different heating element(s) and/or the location of the heating element(s).

According to another aspect of the present disclosure a 3D-printhead further comprises at least one degassing valve and/or ventilation connected to the reservoir. This may have the advantage that the molten build material in the reservoir may be degassed and consequently e.g. occurring gas pockets may be avoided and thus the quality of the workpiece and the reliability of the 3D-printhead may be increased. There may be also or solely a valve and/or ventilation for letting humidity escape from the molten build material in the reservoir. There may be at least one filter connected to the ventilation and/or valve to filter possibly harmful substances.

According to another aspect of the present disclosure a 3D-printhead has a reservoir that is adjustable in its size. This may have the advantage of regulating the inlet pressure for the positive displacement pump.

According to another aspect of the present disclosure a 3D-printhead has a reservoir with a different diameter and/or cross section from the diameter and/or cross section of the liquefier. This may have the advantage that the geometry of the liquefier and the reservoir may be adapted to fit the respective purpose of melting the build material and buffering the molten build material best. For example, the liquefier may have a smaller diameter and/or cross section than the reservoir. Hence, heat energy of the liquefier may enter the build material easier and/or quicker and/or with less loss and melt the build material quicker. The reservoir having a larger diameter and/or cross section than the liquefier may store more molten build material, the molten build material may reduce stresses due to the expansion of the diameter and/or cross section, humidity and/or gasses in the molten build material may escape, the molten build material becomes more homogeneous.

According to another aspect of the present disclosure a reservoir in a 3D-printhead has an entry cross section and an exit cross section. The entry cross section is in the area of a heat sink or a liquefier and exit cross section is in the area of an inlet of a positive displacement pump and wherein the entry cross section is different from the exit cross section. This may have the advantage that the positive displacement pump downstream the reservoir is easier supplied with molten build material.

According to another aspect of the present disclosure a 3D-printer comprises a 3D-printhead according to any of the above aspects and further comprises a Bowden cable and a material feed unit. The material feed unit is located on a static portion of the 3D-printer and the Bowden cable connects the material feed unit with the 3D-printhead. The static portion of the 3D-printer may be the frame or any part/portion of the 3D-printer that does not move like e.g. the gantry system.

For a better understanding of the invention the latter will be explained in view of the appended figures.

The figures respectively show in very simplified and schematically depiction:

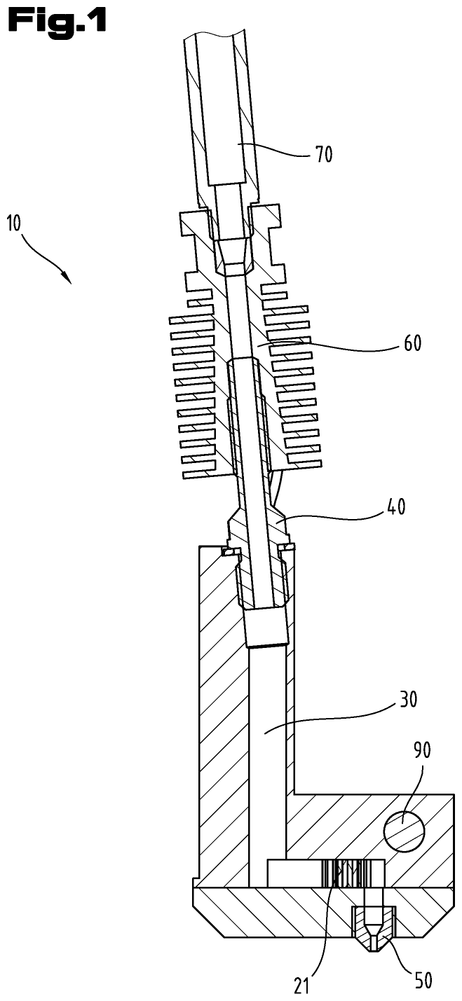

FIG. 1 depicts a schematic cross section of an embodiment of the present invention.

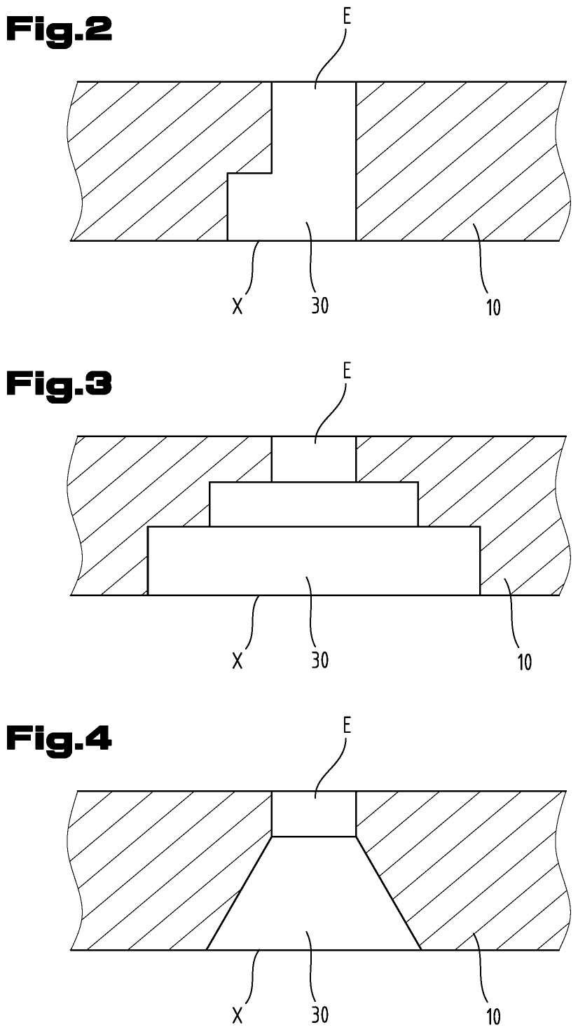

FIG. 2 depicts a schematic cross section of the reservoir depicted in FIG. 1.

FIG. 3 depicts a schematic cross section of another embodiment of a reservoir having different sizes of cross sections.

FIG. 4 depicts a schematic cross section of another embodiment of a reservoir having a funnel-like shape.

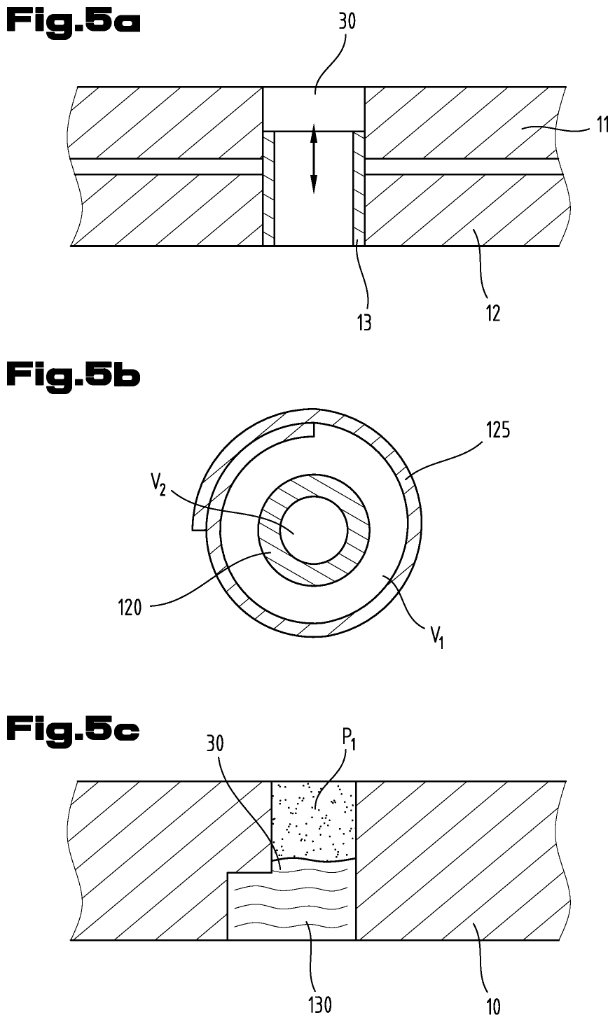

FIG. 5 depicts a schematic cross section of another embodiment of a reservoir having a variable size of reservoir.

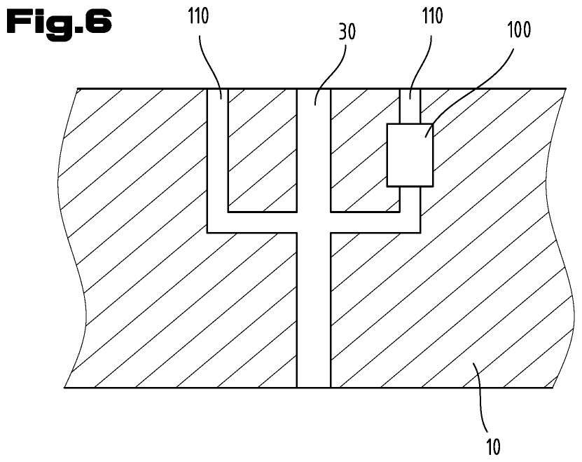

FIG. 6 depicts a schematic cross section of another embodiment of a reservoir having valves for degassing the build material in the reservoir.

It is to be noted that in the different embodiments described herein same parts/elements are numbered with same reference signs, however, the disclosure in the detailed description may be applied to all parts/elements having the regarding reference signs. Also, the directional terms/position indicating terms chosen in this description like up, upper, down, lower downwards, lateral, sideward are referring to the directly described figure and may correspondingly be applied to the new position after a change in position or another depicted position in another figure.

### DETAILED DESCRIPTION OF THE FIGURES

Initially referring to FIG. 1 is an embodiment of the present invention depicted. Like reference sings are used for like or similar parts/elements as in the other figures. Thus, a detailed explanation of such part/element will only be given once for the sake of brevity. A 3D-printhead 10 is depicted in FIG. 1. The 3D-printhead comprises a gear pump 21 as an example of a positive displacement pump, a reservoir 30, a liquefier 40, a nozzle 50, a heat sink 60, a Bowden tube 70 and a heating element 90.

Build material (not shown) is supplied from the top of FIG. 1 through the Bowden tube 70 and through the heat sink 60 into the liquefier 40. Until the build material (e.g. filament) reaches the entry of the liquefier 40, the build material is in a solid and rigid state because the heat of the liquefier 40 cannot act on the build material because of the heat sink 60. In the liquefier 40 the build material is heated up to its respective melting temperature such that it is not longer solid but viscous. Because of the force applied by a material feed unit (not shown) on the build material it is forced into the liquefier 40 and from there into a reservoir 30. The force of the material feed unit can be applied downstream because the build material (e.g. filament) cannot spread because it is guided by the Bowden tube 70, the heat sink 60 and into the liquefier 40. The applied force of the material feed unit increases the pressure in the liquefier 40 and the reservoir 30 and presses the molten build material towards the gear pump 21.

The gear pump 21 conveys the material at a desired deposition rate via a nozzle 50 onto the workpiece/build platform. In this example, the nozzle 50 is screwed in. Since there is always molten build material in the reservoir 30, the gear pump 21 never starves, even if there are considerable fluctuations in the needed deposit rate.

The heating element 90 keeps the reservoir 30 at a desired temperature such as to keep the build material molten by the liquefier 40 in a viscous and conveyable state for the gear pump 21. There may be various heat elements 90 heating the reservoir 30. Also, heat elements 90 may heat up the liquefier 40 (not shown in FIG. 1) in order to melt the build material in the liquefier 40.

FIG. 2 depicts a schematic view of a cross section of the reservoir 30 in FIG. 1. The reservoir in FIGS. 1 and 2 is L-shaped with a different size of cross section at the entry E compared with the size of cross section at the exit X.

FIG. 3 depicts another embodiment of the reservoir 30 of the 3D-printhead 10 having a different entry cross section E from the exit cross section X. Further there is another change of cross section in the reservoir such that there is a discrete intermediate step from the entry cross section E to the exit cross section X.

FIG. 4 depicts another embodiment of the reservoir 30 of the 3D-printhead 10 having a different entry cross section E from the exit cross section X. Here, the reservoir has a funnel-like shape and the entry cross section E gradually changes to the exit cross section X. The funnel-like shape creates certain angled geometry that forces the gas and/or humidity upwards. Also, the area where the molten build material enters the reservoir is better controllable due to its smaller size.

FIG. 5a depicts another embodiment of the reservoir 30 of the 3D-printhead 10. Here, the reservoir 30 is variable in size due to an upper printhead part 11 and a lower printhead part 12. If the parts are approached to each other, the volume of the reservoir 30 reduces and if the parts are spaced, the volume of the reservoir increases. One of the upper or lower printhead parts 11, 12 may comprise a cylinder 13 that extends into the other part and may be sealed off by means of a sealing such as to keep the molten build material (not shown) within the reservoir 30.

FIG. 5b depicts another embodiment of the reservoir 30 having an adjustable size of the 3D-printhead 10. FIG. 5b is a top view onto the reservoir 30. Here an outer cylinder 125 is adjustable in its diameter and an inner cylinder 120 has a fixed diameter and thus occupying a fixes volume V₂ within the variable volume V₁. By changing the diameter of the outer cylinder 125 the volume V₂ changes. Of course, the outer cylinder 125 may be fixed in diameter and the inner cylinder 120 may have a variable diameter.

FIG. 5c depicts another embodiment of the reservoir 30 having an adjustable size of the 3D-printhead 10. The reservoir 30 of FIG. 5c is similar to the reservoir depicted in FIG. 2. However, there is a pressurized gas in the upper part of the reservoir having a pressure pi. The molten build material 130 is depicted in the lower part of the reservoir 30. The amount of molten build material 130 within the reservoir 30 can be adjusted by varying the pressure pi in the reservoir 30. By increasing the pressure pi a force on the surface of the molten material is created. Consequently, it is not possible for new molten build material coming from the liquefier 40 to enter the reservoir 30.

FIG. 6 depicts another embodiment of the reservoir 30 of the 3D-printhead 10. Here, the reservoir has the same entry cross section as the exit cross section. However, there is one degassing valve 100 provided that can degas the molten material 130 (not shown) in the reservoir 30 and consequently prevent gas bubbles from developing. The degassing valve 110 vents by means of a ventilation 110 into an area (e.g. the ambient area) having an atmosphere with a lower pressure than inside the reservoir 30. On the left side of FIG. 6 there is only a ventilation 110 (without the valve 110). Any combination of only a configuration with at least one degassing valve or at least one simple ventilation or a combination of both (as depicted) is possible. At least one filter (not shown) may be attached to the ventilation 110 (irrespective if a degassing valve 100 is present or not).

Except for FIG. 5c no molten build material 130 is depicted within the reservoir 30 for the sake of clarity. Due to the highly variable deposition rate, the amount of molten material 130 is subject to change. In FIGS. 2 to 6 a liquefier 40 would be upstream or above the depicted reservoirs 30 and a positive displacement pump would be downstream or beneath the depicted reservoirs 30.

The embodiments depict possible variations of carrying out the invention, however, it is to be noted that the invention is not limited to the depicted embodiments/variations but numerous combinations of the here described embodiments/variations are possible and these combinations lie in the field of the skills of the person skilled in the art being motivated by this description.

The scope of protection is determined by the appended claims. The description and drawings, however, are to be considered when interpreting the claims. Single features or feature combinations of the described and/or depicted features may represent independent inventive solutions. The object of the independent solutions may be found in the description.

All notations of ranges of values in the present description are to be understood as to also comprise and disclose all arbitrary sub-ranges therein, e.g. the disclosure 1 to 10 is to be understood that all sub-ranges starting from the lower limit 1 up to the upper limit 10 are also comprised and disclosed, i.e. all sub-ranges starting with a lower limit of 1 or bigger and end with an upper limit of 10 or smaller, e.g. 1 to 1.7, or 3.2 to 8.1, or 5.5 to 10. Only one digit after the comma is described, however the same applies mutates mutandis to any given number of digits after the comma.

It is further to be noted that for a better understanding, parts/elements are depicted to some extend not to scale and/or enlarged and/or down scaled.

### REFERENCE SIGN LIST

10 3D-printhead
11 upper printhead part
12 lower printhead part
13 cylinder
20 positive displacement pump
21 gear pump
30 reservoir
40 liquefier
50 nozzle
60 heat sink
70 Bowden tube
90 heating element
100 degassing valve
110 ventilation
120 inner cylinder
125 outer cylinder
130 molten build material
p pressure
V₁, V₂ Volume
E entry cross section
X exit cross section

1. A 3D-printhead (10) comprising a positive displacement pump (20), a reservoir (30) and a liquefier (40), wherein said liquefier is upstream of said reservoir,
and wherein said reservoir is upstream of said positive displacement pump.

2. The 3D-printhead (10) according to claim 1, further comprising at least one of
a nozzle (50)
a heat sink (60), or
a Bowden tube (70)
wherein said Bowden tube is upstream of said heat sink and said liquefier, and wherein said heat sink is upstream of said liquefier, and wherein said positive displacement pump (20) is upstream of said nozzle.

3. The 3D-printhead (10) according to claim 1, further comprising a material feed unit upstream and operatively coupled to one of said Bowden tube (70) or said heat sink (60) or said liquefier (40).

4. The 3D-printhead (10) according to claim 1, wherein the positive displacement pump (20) is gear pump (21).

5. The 3D-printhead (10) according to claim 1, further comprising at least one heating element (90) that heats the reservoir (30).

6. The 3D-printhead (10) according to claim 1, wherein the reservoir (30) has at least two temperature zones.

7. The 3D-printhead (10) according to claim 1, further comprising at least one or a combination of a degassing valve (100), a ventilation (110), a 30 filter connected to the reservoir.

8. The 3D-printhead (10) according to claim 1, wherein the reservoir (30) is adjustable in its size.

9. The 3D-printhead (10) according to claim 1, wherein the reservoir (30) has an entry cross section (E) and an exit cross section (X), and wherein the entry cross section is in the area of the heat sink (60) or the liquefier (40) and exit cross section is in the area of an inlet of the positive displacement pump (20) and wherein the entry cross section is different from the exit cross section.

10. The 3D-printhead (10) according to claim 1, wherein the 10 reservoir (30) has different diameter or cross section than the liquefier (40).

11. The 3D-printer comprising a 3D-printhead (10) according to claim 1, further comprising a Bowden cable and a material feed unit, wherein the material feed unit is located on a static portion of the 3D-printer and the Bowden cable connects the material feed unit with the 3D-printhead.
